(19) United States
(12) Patent Application Publication
(10) Pub. No.: US 2020/0048071 A1
(43) Pub. Date: Feb. 13, 2020

(54) Auxiliary fixing device for unloading oil pipe of metal oil storage tank

(71) Applicant: Liping Ye, Fuqing City (CN)

(72) Inventor: Liping Ye, Fuqing City (CN)

(21) Appl. No.: 16/656,575

(22) Filed: Oct. 18, 2019

(30) Foreign Application Priority Data
Jul. 9, 2019 (CN) 2019106165852

(51) Int. Cl. B67D 7/40

(52) U.S. Cl. CPC B67D 7/40

(57) ABSTRACT

This invention discloses an auxiliary fixing device for unloading oil pipe of metal oil storage tank, including a ground which is provided with a collecting chamber for storing fuel oil, the collecting chamber is provided with an oil port with an opening upward, the external space is provided with a conveyor structure for conveying fuel oil to the collecting chamber. When the device is working, it can fix the oil delivery hose with good fixation, so as to facilitate the stability of the fuel delivery and prevent the fuel leakage. If the fuel delivery vehicle moves automatically in the process of fuel delivery, it pulls the fuel delivery soft. The device can automatically cut off the fuel delivery in the fuel delivery hose, and release the fixation of the fuel delivery hose, so as to directly pull out the fuel delivery hose and prevent a large amount of fuel leakage.

### CROSS-REFERENCES TO RELATED APPLICATIONS

The present application claims priority from Chinese application No. 2019106165852 filed on Jul. 9, 2019 which is hereby incorporated by reference in its entirety.

### TECHNICAL FIELD

The present invention relates to the technical field of fuel delivery, in particular to an auxiliary fixing device for unloading oil pipe of metal oil storage tank.

### BACKGROUND OF THE INVENTION

The fuel oil in the gas station is usually delivered to the gas station by the fuel oil transport vehicle, and then transmitted to the oil storage cavity of the gas station through the oil hose. At present, when transmitting the fuel oil, it is usually necessary to have someone on the side to monitor and assist, so as to prevent accidents caused by external leakage during the fuel oil transmission, which consumes a lot of labor, and quickly pulls the fuel oil transmission when encountering huge force. When the oil hose is used, it is very easy to pull out the oil hose before people react to close the transmission, resulting in fuel leakage, loss and danger.

### BRIEF SUMMARY OF THE INVENTION

The technical problem to be solved by the invention is to provide an auxiliary fixing device for the unloading oil pipe at the outlet of the metal oil storage tank to overcome the problems of large labor consumption and reduce the labor consumption.

The invention is realized by the following technical scheme.

The mechanical structure diagram of the auxiliary fixing device of the unloading oil pipe at the metal oil storage tank port mainly includes the ground, the ground is provided with a collecting chamber which can store fuel oil, the collecting chamber is provided with an oil port with an opening upward, the external space is provided with a conveying mechanism which can deliver fuel oil to the collecting chamber, and the oil port is provided with a solid which can auxiliary fix the oil delivery of the conveying mechanism The fixed block is provided with two moving cavities communicating with the oil port.

The moving cavity is provided with a clamping mechanism which can fix the fixed block in the oil passage port. The clamping mechanism includes a moving plate and two moving springs which can make the moving plate return. The moving plate is provided with a spring cavity which is connected with the moving cavity. The spring cavity is provided with a spring plate and two extension springs which can make the spring plate return. The spring cavity There is also a limit plate slidably connected with the spring plate, one end face of the limit plate is fixed with a clamping rod, the moving cavity is also provided with a lifting block, the lower end of the lifting block is fixed with a lifting spring connected with the clamping rod at the lower end, the left and right sides of the lifting block are provided with two restriction blocks penetrating the clamping rod, the upper end of the lifting block is fixed with a connecting block, and the upper end of the lifting block is fixed with a connecting block. A limiting groove is arranged in the connecting block, and a limiting block is arranged in the limiting groove. The upper end of the limiting block is fixed with a rope which can drive the limiting block to rise. The moving cavity is provided with a driving mechanism which can be driven to move when delivering fuel oil. When delivering fuel oil, the driving mechanism outputs power and controls the clamping rod in the clamping mechanism to rise and causes the clamping rod to rise. Contacting with the upper end wall of the collection chamber, thereby realizing the fixation of the conveying mechanism and ensuring the stability of the oil transportation;

The moving cavity is also provided with a control mechanism which automatically cuts off the conveying when the conveying mechanism encounters an emergency.

Further, the conveying mechanism includes an oil delivery hose, the left end of the oil delivery hose is fixed with a spiral block, the left side of the spiral block is provided with an oil outlet connected with the spiral block by thread, the oil outlet is provided with an oil outlet pump, the right end of the oil delivery hose is penetrated through the oil outlet and the fixed block, and is located in the collection cavity, and the right end of the oil delivery hose is also fixed with a restriction. The oil hose completely enters the limiting plate in the collection cavity, the left end face of the oil hose located in the external space is fixed with two fixing plates, the elastic rope is fixed between the two fixing plates, and two contact switches are fixed on the elastic rope.

Further, the clamping mechanism also includes two lifting chambers, the lifting chamber is located in the oil delivery hose and is connected with the inner part of the oil delivery hose, the oil delivery hose is provided with a spring block with one end located in the inner part of the oil delivery pipeline and a compression spring which can make the spring block return, one end of the spring block is fixed with one end penetrating the lower wall of the mobile chamber and rising with the Falling block connected chain.

Further, the transmission mechanism comprises a transmission shaft with one end rotationally connected with the moving chamber and the other end in the oil hose, the transmission shaft in the oil hose is fixed with a rotating fan leaf, the transmission shaft in the moving chamber is slidably connected with a rope winding wheel, the end wall of the moving chamber is fixed with a driven spring with one end in contact with the rope winding wheel. The transmission shaft is also slidably connected with a transmission wheel, one end face of the transmission wheel is fixed with a connecting rod, the winding wheel is provided with a connecting groove which is connected with the moving cavity, one end of the connecting rod is located in the connecting groove, one end of the rope is wound on the winding wheel, the transmission shaft is also fixed with a centrifugal wheel, and the centrifugal wheel is also provided with twelve connected with the moving The spring groove of the cavity is provided with a ejecting block with one end in the moving cavity and a stretching spring which can make the ejecting block return.

Further, the control mechanism also includes a closing plate which can cut off the oil delivery of the oil delivery hose. One end of the closing plate is located in the moving cavity and the lower end surface is fixed with a half round block. The end wall at one side of the moving cavity is provided with electromagnetic iron which can repel and absorb the closing plate. The end wall at one side of the moving cavity is fixed with a support block, and the upper side of the support block is provided with a support plate. The support plate and the support block are connected by a support spring, the lower end surface of the support plate is fixed with a trapezoid block which can separate the rope reeling wheel and the driving wheel, the upper end surface of the support plate is fixed with a second semicircle block, the closed plate in the left control mechanism is provided with a storage groove with an opening to the right, and the left end of the closed plate in the right control mechanism is fixed There are connecting columns.

Further, the friction force between the rope reeling wheel and the transmission shaft is far less than the friction force between the transmission wheel and the transmission shaft.

Further, when the two contact switches are separated from each other, the electromagnet can be controlled to work and repel the closing plate.

The device has the advantages of simple structure and convenient operation. When the device is in operation, it can fix the fuel delivery hose with good fixation, so as to facilitate the stability of fuel delivery and prevent fuel leakage. If the fuel delivery vehicle moves automatically in the process of fuel delivery, so as to pull the fuel delivery hose, the device can automatically cut off the fuel delivery in the fuel delivery hose and automatically release it. The fixing of the fuel delivery hose is convenient to pull out the fuel delivery hose directly and prevent a large amount of fuel leakage.

### BRIEF DESCRIPTION OF THE DRAWINGS

In order to explain the embodiments of the invention or the technical solutions in the prior art more clearly, the following will give a brief introduction to the drawings needed in the embodiments or the prior art description. It is obvious that the drawings in the following description are only some embodiments of the invention. For ordinary technicians in the skill field, they can also use these drawings without paying creative labor. Other figures are obtained from the figures.

FIG. 1 is the overall schematic structural diagram of the invention;

FIG. 2 is a schematic diagram of the main view amplification structure of the fixed block full section in the embodiment of the invention;

FIG. 3 is the left view enlarged structure of the centrifugal wheel full section in the embodiment of the invention;

FIG. 4 is a left view enlarged schematic diagram of the full section of the structure at the lifting block of the embodiment of the invention.

### DETAILED DESCRIPTION OF THE INVENTION

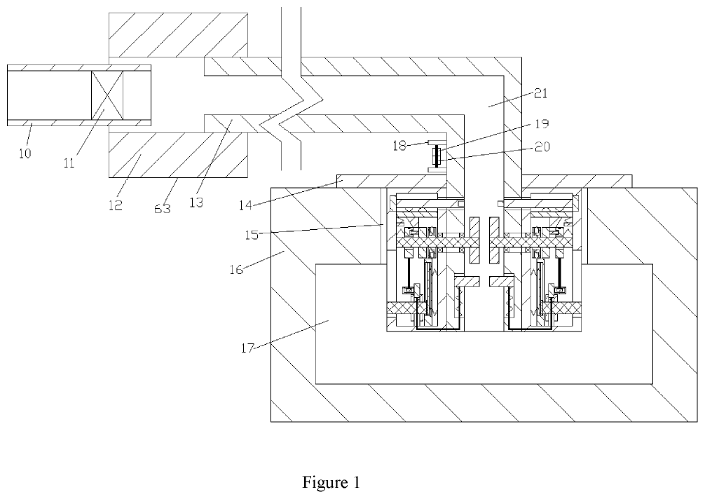

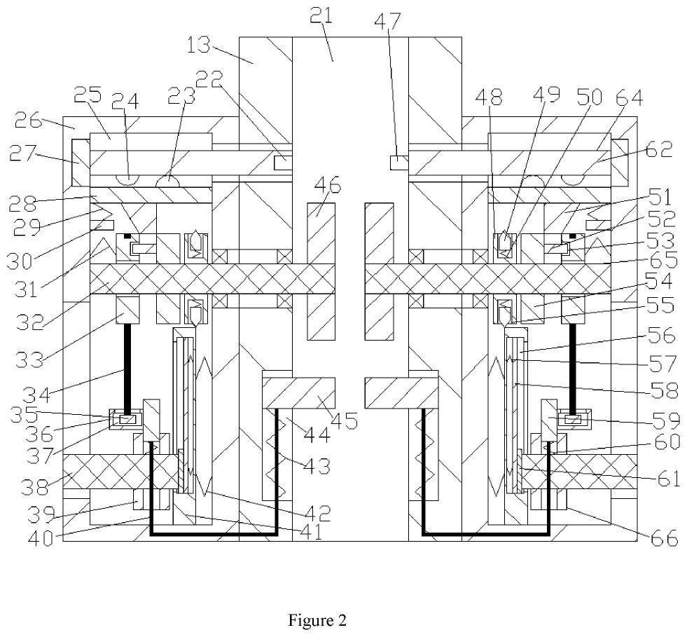

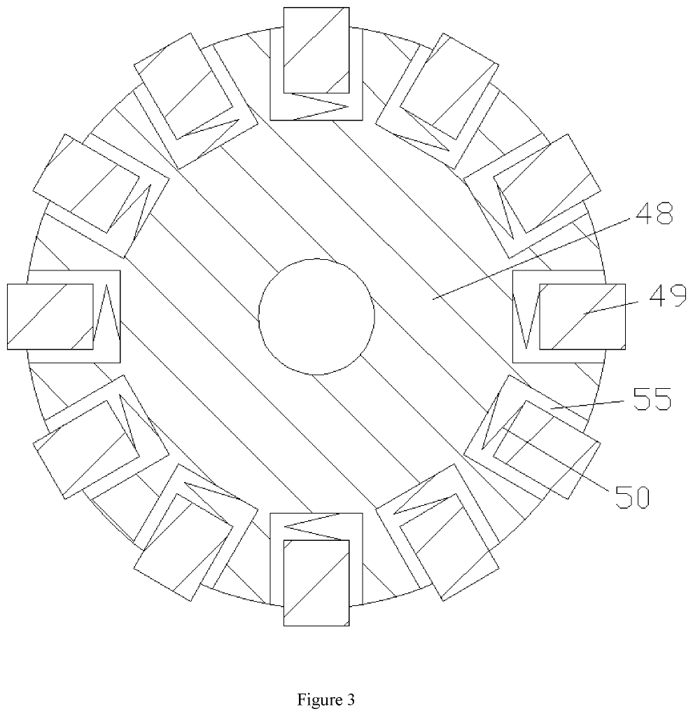

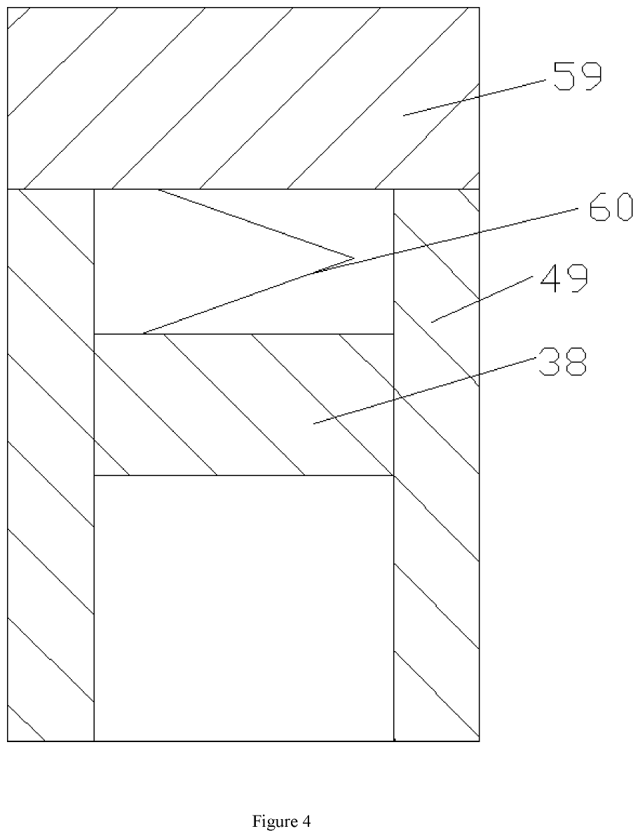

According to the mechanical structure diagram of the auxiliary fixing device for the discharge oil pipe at the metal oil storage tank opening described in FIG. 1-4, it mainly includes the ground 16, wherein the ground 16 is provided with a collecting chamber 17 for storing fuel oil, the collecting chamber 17 is provided with an oil port 15 with an opening upward, the external space is provided with a conveying mechanism 63 for conveying fuel oil to the collecting chamber 17, and the oil port 15 is provided with an auxiliary fixing chamber The fixed block 26 for oil transportation of the conveying mechanism 63 is provided with two moving cavities 25 communicating with the oil passage 15, and the moving cavity 25 is provided with a clamping mechanism 66 which can fix the fixed block 26 in the oil passage 15. The clamping mechanism 66 includes a moving plate 41 and two moving springs 42 which can reset the moving plate 41. The moving plate 41 is provided with a moving spring 42 communicating with the moving plate 41 The spring chamber 56 of the moving chamber 25 is provided with a spring plate 58 and two expansion springs 57 which can make the spring plate 58 return. The spring chamber 56 is also provided with a limit plate 61 which is slidably connected with the spring plate 58. The end face of the limit plate 61 is fixed with a clamping rod 38, the moving chamber 25 is also provided with a lifting block 59, and the lower end of the lifting block 59 is fixed with the clamping rod 38. The lifting spring 60 connected with the rod 38 is provided with two limit blocks 39 which are penetrated by the clamping rod 38 on the left and right sides of the lifting block 59. The upper end of the lifting block 59 is fixed with a connecting block 36, the connecting block 36 is provided with a limiting groove 37, the limiting groove 37 is provided with a limiting block 35, the upper end of the limiting block 35 is fixed with a rope 34 which can drive the limiting block 35 to rise, and the moving cavity 25 is provided with a limiting block 36. The driving mechanism 65 can be driven to move when delivering fuel oil. When delivering fuel oil, the driving mechanism 65 can work to output power and control the clamping rod 38 in the clamping mechanism 66 to rise and make the clamping rod 38 contact with the upper end wall of the collection chamber 17, so as to realize the fixation of the conveying mechanism 63 and ensure the stability of oil delivery. The moving chamber 25 is also provided in the conveying mechanism Mechanism 63 automatically cuts off the conveying control mechanism 64 in case of emergency.

Advantageously, the conveying mechanism 63 includes an oil hose 13, the left end of the oil hose 13 is fixed with a spiral block 12, the left side of the spiral block 12 is provided with an oil outlet 10 which is threaded with the spiral block 12, the oil outlet 10 is provided with an oil outlet 11, the right end of the oil hose 13 is penetrated through the oil outlet 15 and the fixed block 26, and is located in the collection cavity 17, and the right end of the oil hose 13 is located The end is also fixed with a limiting plate 14 restricting the oil hose 13 from entering the collection chamber 17 completely, the left end surface of the oil hose 13 located in the external space is fixed with two fixing plates 18, and an elastic rope 19 is fixed between the two fixing plates 18, and two contact switches 20 in contact with each other are fixed on the elastic rope 19.

Advantageously, the clamping mechanism 66 also includes two lifting cavities 44, wherein the lifting cavity 44 is located in the oil hose 13 and is connected with the internal part of the oil hose 13, wherein the oil hose 13 is provided with a spring block 45 with one end located in the internal part of the oil pipeline 13 and a compression spring 43 which can make the spring block 45 return. One end of the spring block 45 is fixed with one end running through the moving cavity 25 A chain 40 having an end wall and connected with the lifting block 59.

According to an embodiment, the lifting device 101 is described in detail below; the lifting device 101 comprises a lifting shaft 43 which extends horizontally and is rotatably connected to the main cavity 15; a main sprocket wheel 42 is fixedly connected to the lifting shaft 43; a first end of the lifting shaft 43 is in power connection with the lifting motor 28; a sprocket wheel shaft 36, which extends horizontally and is located at a lower side of the lifting shaft 43, is rotatably connected to the main cavity 15; a sprocket wheel 35 is fixedly connected to the sprocket wheel shaft 36; two of transmissive chains 12 are horizontally symmetrically connected between the sprocket wheel 35 and the main sprocket wheel 42; a fixing rod 13 is fixedly connected between the two of the transmissive chains 12; two of locating dowels 14 of bilateral symmetry are fixedly connected to a front end of the fixing rod 13; pinholes 97 which are penetrated horizontally are disposed on front ends of the locating dowels 14; two of fixing blocks 16 are symmetrically and fixedly connected to the inner walls on the both sides of the main cavity 15; the fixing blocks 16 on both sides are respectively fixedly connected to the two of the infrared transmitters 17 in the lifting device 101; a scanning rod 19 located at an upper side of the fixing blocks 16 is fixedly connected to the inner walls on the both sides of the main cavity 15; a scanner 18 is fixedly connected to the scanning rod 19.

Advantageously, the transmission mechanism 65 includes a transmission shaft 32 with one end rotationally connected with the moving cavity 25 and the other end in the oil hose 21, the transmission shaft 32 in the oil hose 21 is fixed with a rotating fan leaf 46, the transmission shaft 32 in the moving cavity 25 is slidably connected with a rope winding wheel 33, and the end wall of the moving cavity 25 is fixed with one end in contact with the rope winding wheel 33. The driven spring 31, the drive shaft 32 is also slidably connected with the drive wheel 54, the end face of the drive wheel 54 is fixed with a connecting rod 52, the rope winding wheel 33 is provided with a connecting groove 53 communicating with the moving cavity 25, one end of the connecting rod 52 is located in the connecting groove 53, one end of the rope 34 is wound on the winding wheel 33, and the drive shaft 32 is also fixed with a centrifugal wheel 48, and The centrifugal wheel 48 is also provided with twelve spring grooves 55 communicating with the moving chamber 25. The spring grooves 55 are provided with a ejecting block 49 with one end in the moving chamber 25 and a stretching spring 50 which can make the ejecting block 49 return.

Advantageously, the control mechanism 64 also includes a closing plate 62 which can cut off the oil delivery of the oil delivery hose 13. One end of the closing plate 62 is located in the moving chamber 25 and the lower end surface is fixed with a half round block 24. An electromagnet 27 which can repel and attract the closing plate 62 is arranged in the end wall of the moving chamber 25. The end wall of the moving chamber 25 is fixed with a support block 30 which is on the support block 30 The side is provided with a support plate 28, which is connected with the support block 30 through a support spring 29, the lower end surface of the support plate 28 is fixed with a trapezoid block 51 which can separate the rope reeling wheel 33 from the driving wheel 54, the upper end surface of the support plate 28 is fixed with a second half round block 23, the closed plate 62 in the left control mechanism 64 is provided with a storage groove 22 with an opening to the right, and the right side is provided with a storage groove 22. The left end of the closing plate 62 in the control mechanism 64 is fixed with a connecting column 47.

Advantageously, the friction force between the rope reeling wheel 33 and the transmission shaft 32 is far less than the friction force between the transmission wheel 54 and the transmission shaft 32.

Advantageously, when the two contact switches 20 are separated from each other, the electromagnet 27 can be controlled to work and repel the closing plate 62.

Mechanical action sequence of the whole device:

1: screw the screw block 12 on the right end of the oil outlet 10, put the right end of the oil hose 13 into the collection chamber 17 through the oil port 15, contact the limit plate 14 with the ground 16, open the oil outlet pump 11, so as to deliver fuel to the collection chamber 17;

2: the fuel oil flows in the oil delivery hose 13, which drives the rotation of the rotating fan 46 and lowers the spring block 45, compresses the spring 43, and relaxes the chain 4. The rotation of the rotating fan 46 drives the rotation of the transmission shaft 32, which drives the rotation of the centrifugal wheel 48, which drives the ejecting block 49 to leave the spring groove 55, which drives the movement of the moving plate 41, so that the clamping rod 38 is ejected, and the rotation of the transmission shaft 32 is driven. The driving wheel 54 rotates, so as to drive the rope winding wheel 33 to rotate, so as to tighten the rope 34, so as to drive the limit block 35 to rise, so as to drive the connecting block 36 to rise with the lifting block 59, so as to raise the clamping rod 38 until one end of the clamping rod 38 located in the collection chamber 17 contacts with the upper end wall of the collection chamber 17, at this time, the clamping rod 38 does not rise, while the lifting block 59 continues to rise, and the lifting spring 6 is stretched. So that the fixing block 26 is fixed in the oil port 15 under the coordination of the limiting plate 14 and the clamping rod 38;

3: when the lifting block 59 no longer rises, the transmission shaft 32 no longer drives the transmission wheel 54 to rotate, and the oil transportation stops, the publicity fan 46 stops rotating, and the lifting spring 45 is reset, so that the spring block 45 is reset, so that the lifting block 59 is lowered through the transmission of the chain 40, so that the clamping rod 38 is lowered and no longer contacted with the upper end wall of the collection chamber 17, and the centrifugal wheel 48 does not rotate, so as to make the ejector block 49 Under the action of the extension spring 50, the moving plate 41 is reset under the action of the moving spring 42, so that the clamping rod 38 is returned to the moving chamber 25, so as to take out the fixing block 26 conveniently;

4: in case of emergency, when the oil hose 13 is pulled with great force, the oil hose 13 is first stretched to the maximum expansion amount, at this time, the distance between the two fixed plates 18 increases, so that the elastic rope 19 is stretched, so that the contact switch 20 is separated, so as to control the electromagnet 27 and the closing plate 62 to repel each other, so as to control the closing plate 62 to cut off the oil hose 13, because the movement of the closing plate 62 has not yet been completed. Cut off the oil delivery hose 13 so that the first half of the round block 24 first drives the second half of the round block 23 down, thus driving the support plate 28 down, so that the trapezoid block 51 is lowered, so that the rope reel 33 is separated from the driving wheel 54, so that the connecting rod 52 leaves the connecting groove 53, so that the lifting block 59 is reset under the action of the lifting spring 60, the rope 34 is loosened, so that the clamping rod 38 moves downward. When the closing plate 62 When the closed fuel delivery hose 13 is moved and the internal fuel of the fuel delivery hose 13 at the lower side of the closed plate 62 is exhausted, the spring block 45 and the rotating fan blade 46 are both reset, so that the moving plate 41 is reset, so as to pull out the fuel delivery hose 13 with great force and prevent fuel leakage.

The above embodiments are only to illustrate the technical concept and features of the invention, and the purpose is to enable people familiar with the technology in the field to understand the content of the invention and implement it, and not to limit the scope of protection of the invention. Any equivalent change or modification according to the spirit and substance of the invention shall be covered in the protection scope of the invention.

1. An auxiliary fixing device for unloading oil pipe of metal oil storage tank, comprising the ground, which is characterized in that: the ground is provided with a collecting chamber for storing fuel oil, the collecting chamber is provided with an oil port with an opening upward, the external space is provided with a conveying mechanism for delivering fuel oil to the collecting chamber, and the oil port is provided with a fixing block for auxiliary fixing the oil delivery of the conveying mechanism; two moving cavities are arranged in the fixed block to connect the oil port;
the moving cavity is provided with a clamping mechanism which can fix the fixed block in the oil passage port. The clamping mechanism includes a moving plate and two moving springs which can make the moving plate return. The moving plate is provided with a spring cavity which is connected with the moving cavity. The spring cavity is provided with a spring plate and two extension springs which can make the spring plate return. The spring cavity There is also a limit plate slidably connected with the spring plate, one end face of the limit plate is fixed with a clamping rod, the moving cavity is also provided with a lifting block, the lower end of the lifting block is fixed with a lifting spring connected with the clamping rod at the lower end, the left and right sides of the lifting block are provided with two restriction blocks penetrating the clamping rod, the upper end of the lifting block is fixed with a connecting block, and the upper end of the lifting block is fixed with a connecting block. A limiting groove is arranged in the connecting block, and a limiting block is arranged in the limiting groove. The upper end of the limiting block is fixed with a rope which can drive the limiting block to rise. The moving cavity is provided with a driving mechanism which can be driven to move when delivering fuel oil. When delivering fuel oil, the driving mechanism outputs power and controls the clamping rod in the clamping mechanism to rise and causes the clamping rod to rise. Contacting with the upper end wall of the collection chamber, thereby realizing the fixation of the conveying mechanism and ensuring the stability of the oil transportation;
the moving cavity is also provided with a control mechanism which automatically cuts off the conveying when the conveying mechanism encounters an emergency.

2. The auxiliary fixing device for unloading oil pipe of metal oil storage tank as defined in claim 1, wherein The conveying mechanism includes an oil delivery hose, the left end of the oil delivery hose is fixed with a spiral block, the left side of the spiral block is provided with an oil outlet connected with the spiral block by thread, the oil outlet is provided with an oil outlet pump, the right end of the oil delivery hose runs through the oil outlet and the fixed block and is located in the collection cavity, and the right end of the oil delivery hose is also fixed with a restriction on the oil delivery hose the limiting plate which completely enters the collection cavity is fixed with two fixing plates on the left end face of the oil hose located in the external space, elastic rope is fixed between the two fixing plates, and two contact switches are fixed on the elastic rope.

3. The auxiliary fixing device for unloading oil pipe of metal oil storage tank as defined in claim 1, wherein The clamping mechanism also includes two lifting chambers, the lifting chamber is located in the oil hose and is connected with the inner part of the oil hose, the oil hose is provided with a spring block with one end located in the inner part of the oil pipeline and a compression spring which can make the spring block return, one end of the spring block is fixed with one end penetrating the lower wall of the moving chamber and connected with the lifting block.

4. The auxiliary fixing device for unloading oil pipe of metal oil storage tank as defined in claim 1, wherein The transmission mechanism comprises a transmission shaft with one end rotationally connected with the moving chamber and the other end in the oil hose, the transmission shaft in the oil hose is fixed with a rotating fan leaf, the transmission shaft in the moving chamber is slidably connected with a rope winding wheel, the end wall of the moving chamber is fixed with a driven spring with one end in contact with the rope winding wheel, and the transmission shaft also has a driving wheel is slidably connected, one end face of the driving wheel is fixed with a connecting rod, one end of the connecting rod is located in the connecting groove, one end of the rope is wound on the winding wheel, the driving shaft is also fixed with a centrifugal wheel, and the centrifugal wheel is also provided with twelve spring grooves connected with the moving cavity The spring groove is provided with a ejecting block with one end in the moving cavity and a stretching spring which can make the ejecting block reset.

5. The auxiliary fixing device for unloading oil pipe of metal oil storage tank as defined in claim 1, wherein the control mechanism also comprises a closing plate which can cut off the oil delivery of the oil delivery hose, one end of the closing plate is located in the moving cavity and the lower end surface is fixed with a half round block, an electromagnet which can repel and attract the closing plate is arranged in the end wall at one side of the moving cavity, a supporting block is fixed on the end wall at one side of the moving cavity, and a supporting plate is arranged on the upper side of the supporting block The support plate is connected with the support block by a support spring, the lower end surface of the support plate is fixed with a trapezoid block which can separate the rope reeling wheel and the driving wheel, the upper end surface of the support plate is fixed with a second half round block, the closed plate in the left control mechanism is provided with a storage groove with an opening to the right, and the left end of the closed plate in the right control mechanism is fixed with a connection column.

6. The auxiliary fixing device for unloading oil pipe of metal oil storage tank as defined in claim 4, wherein The friction force between the rope reeling wheel and the transmission shaft is far less than the friction force between the transmission wheel and the transmission shaft.

7. The auxiliary fixing device for unloading oil pipe of metal oil storage tank as defined in claim 2, wherein When the two contact switches are separated from each other, the electromagnet can be controlled to work and repel the closing plate.
